(19) United States
(12) Patent Application Publication
(10) Pub. No.: US 2007/0224509 A1
(43) Pub. Date: Sep. 27, 2007

(54) SiCO-Li COMPOSITE, MAKING METHOD, AND NON-AQUEOUS ELECTROLYTE SECONDARY CELL NEGATIVE ELECTRODE MATERIAL

(75) Inventors: Mikio Aramata, Annaka-shi (JP); Koichiro Watanabe, Annaka-shi (JP); Satoru Miyawaki, Annaka-shi (JP); Meguru Kashida, Annaka-shi (JP); Hirofumi Fukuoka, Annaka-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Shin-Etsu Chemical Co., Ltd., Chiyoda-ku (JP)

(21) Appl. No.: 11/689,671

(22) Filed: Mar. 22, 2007

(30) Foreign Application Priority Data
Mar. 27, 2006 (JP) 2006-085440

(51) Int. Cl. H01M 4/58; C01B 33/32

(52) U.S. Cl. 429/231.95; 423/332

(57) ABSTRACT

A SiCO—Li composite is prepared by causing a reactive silane and/or siloxane having crosslinkable groups to crosslink, sintering the crosslinked product into an inorganic Si—C—O composite, and doping the Si—C—O composite with lithium. When the SiCO—Li composite is used as a negative electrode, a lithium ion secondary cell exhibits good cycle performance, unique discharge characteristics and improved initial efficiency.

### CROSS-REFERENCE TO RELATED APPLICATION

This non-provisional application claims priority under 35 U.S.C. §119(a) on Patent Application No. 2006-085440 filed in Japan on Mar. 27, 2006, the entire contents of which are hereby incorporated by reference.

### TECHNICAL FIELD

This invention relates to a SiCO—Li composite useful as negative electrode material for non-aqueous electrolyte secondary cells; a method for preparing the same; and a non-aqueous electrolyte secondary cell negative electrode material comprising the composite.

### BACKGROUND ART

With the recent remarkable development of potable electronic equipment, communications equipment and the like, a strong demand for high energy density secondary batteries exists from the standpoints of economy and size and weight reductions. One prior art method for increasing the capacity of secondary batteries is to use oxides as the negative electrode material, for example, oxides of V, Si, B, Zr, Sn or the like or complex oxides thereof (see JP-A 5-174818 and JP-A 6-060867 corresponding to U.S. Pat. No. 5,478,671), metal oxides quenched from the melt (JP-A 10-294112), silicon oxide (Japanese Patent No. 2,997,741 corresponding to U.S. Pat. No. 5,935,711), and Si₂N₂O and Ge₂N₂O (JP-A 11-102705 corresponding to U.S. Pat. No. 6,066,414). Conventional methods of imparting conductivity to the negative electrode material include mechanical alloying of SiO with graphite, followed by carbonization (see JP-A 2000-243396 corresponding to U.S. Pat. No. 6,638,662), coating of silicon particles with a carbon layer by chemical vapor deposition (JP-A 2000-215887 corresponding to U.S. Pat. No. 6,383,686), coating of silicon oxide particles with a carbon layer by chemical vapor deposition (JP-A 2002-042806), and formation of a film using a polyimide binder followed by sintering (JP-A 2004-022433 corresponding to US 2003-0235762 A).

The foregoing prior art methods are successful in increasing the charge/discharge capacity and energy density, but still leave several problems including insufficient cycle performance, substantial volume changes of the negative electrode film upon charge/discharge cycles, and delamination from the current collector. They fail to fully meet the characteristics required in the market and are thus not necessarily satisfactory. It would be desirable to have a negative electrode active material having improved cycle performance and a high energy density.

In particular, Japanese Patent No. 2,997,741 uses silicon oxide as the negative electrode material in a lithium ion secondary cell to provide an electrode with a high capacity. As long as the present inventors have confirmed, there is left a room for further improvement as demonstrated by a still high irreversible capacity on the first charge/discharge cycle and cycle performance below the practical level. With respect to the technique of imparting conductivity to the negative electrode material, JP-A 2000-243396 suffers from the problem that solid-to-solid fusion fails to form a uniform carbon coating, resulting in insufficient conductivity. In the method of JP-A 2000-215887 which can form a uniform carbon coating, the negative electrode material based on silicon undergoes excessive expansion and contraction upon adsorption and desorption of lithium ions, meaning impractical operation, and loses cycle performance. Thus, the charge quantity must be limited. In JP-A 2002-042806, despite a discernible improvement of cycle performance, due to precipitation of silicon crystallites, insufficient structure of the carbon coating and insufficient fusion of the carbon coating to the substrate, the capacity gradually lowers as charge/discharge cycles are repeated, and suddenly drops after a certain number of charge/discharge cycles. This approach is thus insufficient for use in secondary cells.

### SUMMARY OF THE INVENTION

An object of the present invention is to provide a SiCO—Li composite in which an Si—C—O composite which enables to manufacture a negative electrode for a lithium ion secondary cell having better cycle performance is doped with lithium so that the Si—C—O composite's drawback of low initial efficiency is overcome; a method for preparing the same; and a non-aqueous electrolyte secondary cell negative electrode material.

The inventor discovered a Si—C—O material which is successful, despite a somewhat inferior capacity to silicon and silicon oxide, in improving the cycle performance over the silicon and silicon oxide based materials and minimizing the volume change during charge/discharge cycles which has been an outstanding issue with the siliceous negative electrode active materials. This discovery was based on the background that it was then known that an initial irreversible capacity can be complemented by incorporating metallic lithium and/or organolithium compounds into a lithium ion secondary cell. Reference should be made to JP-A 11-86847, JP-A 2004-235057, JP-A 2004-303597 for the addition of metallic lithium; and JP-A 5-226003 corresponding to U.S. Pat. No. 5,316,875 and GS News Technical Report, Vol. 62-2, p. 63 (2003) for the addition of organic lithium.

At the early stage, it was considered that the lithium incorporation achieves an abundant effect even though the inclusion of an addition step is subtractive. However, in the actual process of manufacturing lithium ion secondary cells, the inclusion of the lithium addition step raises many problems and is impractical. There remained a need for a negative electrode material which is improved in initial efficiency while maintaining the desired characteristics of Si—C—O material.

The development of an electrode material having an increased charge/discharge capacity is very important and many engineers have been engaged in the research and development thereof. Under the circumstances, silicon, silicon oxides (SiOₓ) and silicon alloys are of great interest as the negative electrode active material for lithium ion secondary cells because of their large capacity. However, only few of them have been used in practice because of their shortcomings including substantial degradation upon repeated charge/discharge cycles, that is, poor cycle performance, and in the case of silicon oxides, low initial efficiency. Making investigations from such a standpoint with the target of improving cycle performance and initial efficiency, the inventor found that thermal CVD treatment of silicon oxide powder to provide a carbon coat led to a substantial improvement in performance as compared with the prior art (JP-A 2004-063433 corresponding to US 2003-0118905 A). Continuing a study on the stable structure having alleviated the volume change associated with occlusion and release of lithium, the inventor found that the above problems of lithium ion secondary cell negative electrode active material are overcome by coating surfaces of silicon or silicon alloy microparticulates with an inert robust substance such as Si—C, Si—C—O or Si—N composite, granulating and introducing voids in the interior. The resulting material has a consistent high charge/discharge capacity and achieves drastic improvements in cyclic charge/discharge operation and efficiency thereof. See JP-A 2005-310759 corresponding to US 2005-0214644 A.

From the capacity standpoint, however, siliceous materials have charge/discharge capacities which are unnecessarily high in some applications. It would thus be desirable to have a material having a capacity which is only about 1.5 to 3 times the current carbon-based materials and better cycle performance.

Continuing a study on the stable structure having alleviated the volume change associated with occlusion and release of lithium, the inventor has found that a Si—C—O composite obtained by heating a silane and/or siloxane compound, which has been highly crosslinked through addition reaction or the like, in an inert gas stream and pulverizing the resulting sintered product has a capacity as the lithium ion cell negative electrode material which is somewhat inferior to silicon oxide-based materials, but is drastically improved in long-term stability. Additionally, a Si—C—O composite obtained by previously adding a graphite based material, which is currently used as the lithium ion secondary cell negative electrode active material, to a silane and/or siloxane compound in the uncured state, followed by similar curing, sintering and pulverization has a capacity which is higher than the graphite based material and controllable to any desired value, and improved properties including cycle performance. See Japanese Patent Application No. 2006-062949 (U.S. Ser. No. 11/185,902, Published Application No. 2006-022198; China Patent Application No. 20051124903.1, Published Application No. 1758466). However, the material still suffers from a low initial efficiency inherent to Si—C—O composite.

Continuing further investigations with a focus on Si—C—O composite toward the goal of improving the initial efficiency thereof while maintaining the capacity and cycle performance, the inventor has found that a SiCO—Li composite obtained by doping the Si—C—O composite with metallic lithium and/or organolithium compound has a high initial efficiency as well as a high capacity and excellent cycle performance, and that thermal CVD treatment of SiCO—Li composite to provide a carbon coat leads to a substantial improvement in performance as compared with the prior art. Then the above-described problems of lithium ion secondary cell negative electrode active material are overcome. The resulting material has a consistent high charge/discharge capacity and achieves drastic improvements in cyclic charge/discharge operation and efficiency thereof. An effective method for producing the material has also been found.

Therefore, the present invention provides a SiCO—Li composite, a method for preparing the same, and a non-aqueous electrolyte secondary cell negative electrode material, as defined below.

In one aspect, the invention provides a SiCO—Li composite prepared by sintering a crosslinked product of a reactive silane or siloxane having crosslinkable groups or a mixture thereof into an inorganic Si—C—O composite, and doping the Si—C—O composite with metallic lithium or an organolithium compound.

In a preferred embodiment, the crosslinked product is spherical silicone powder.

In a preferred embodiment, a particulate additive selected from the group consisting of graphite and silicon powder, and graphite and silicon powder which have been surface treated with an organosilicon surface treating agent is added to the reactive silane or siloxane having crosslinkable groups or the mixture thereof, prior to the formation of the crosslinked product.

In a preferred embodiment, the reactive silane or siloxane is one or more of silanes or siloxanes having the general formulae (1) to (5):

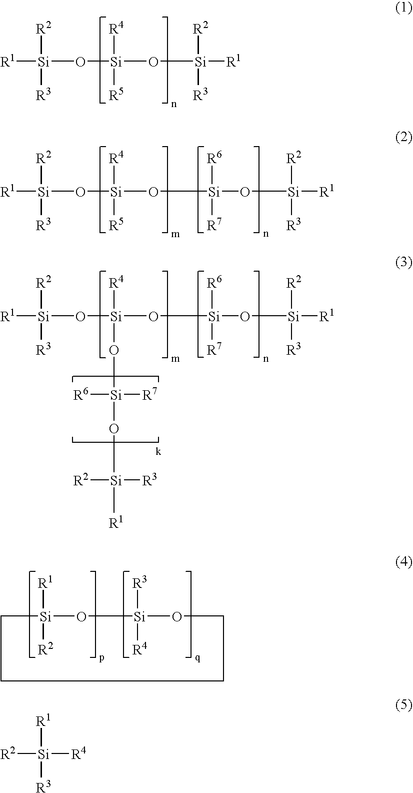

wherein R¹ to R⁷ are each independently a hydrogen atom, hydroxyl group, hydrolyzable group or monovalent hydrocarbon group, with the proviso that in each of the compounds of formulae (1) to (5), at least two silicon-bonded substituent groups are hydrogen atoms, hydroxyl groups, hydrolyzable groups or aliphatic unsaturated hydrocarbon groups, m, n and k each are a number of 0 to 2,000, p and q each are a number of 0 to 10, p and q are not equal to 0 at the same time.

In a preferred embodiment, the reactive silane or siloxane is derived from a silane or siloxane having the average formula: C_{w}HₓSiO_{y}N_{z} wherein w and x are positive numbers, y and z are 0 or positive numbers, and (w−y) is greater than 0, and including at least one crosslinkable site per four silicon atoms.

Typically the SiCO—Li composite has an average particle size of 0.1 to 30 μm.

A surface conductive SiCO—Li composite is obtained when the SiCO—Li composite defined above is surface coated with carbon.

In another aspect, the invention provides a method for preparing a SiCO—Li composite comprising the steps of curing a reactive silane or siloxane having crosslinkable groups or a mixture thereof through heat curing or catalytic reaction to form a crosslinked product; sintering the crosslinked product in an inert gas stream at a temperature in the range of 700 to 1,400° C. into an inorganic Si—C—O composite; and adding metallic lithium or an organolithium compound to the Si—C—O composite for doping.

Also provided is a method for preparing a SiCO—Li composite comprising the steps of crosslinking a reactive silane or siloxane having crosslinkable groups or a mixture thereof by an emulsion process to form a spherical silicone powder; sintering the powder in an inert gas stream at a temperature in the range of 700 to 1,400° C. into an inorganic Si—C—O composite; and adding metallic lithium or an organolithium compound to the Si—C—O composite for doping.

The method may further comprise the step of adding an additive to the reactive silane or siloxane having crosslinkable groups or the mixture thereof, prior to the curing or crosslinking step, the additive serving as conductive agent and/or lithium-occluding material and being selected from the group consisting of graphite and silicon powder, and graphite and silicon powder which have been surface treated with at least one organosilicon surface treating agent selected from among silane coupling agents, (partial) hydrolyzates thereof, silylating agents, and silicone resins.

In a preferred embodiment, the reactive silane or siloxane is one or more of silanes or siloxanes having the general formulae (1) to (5):

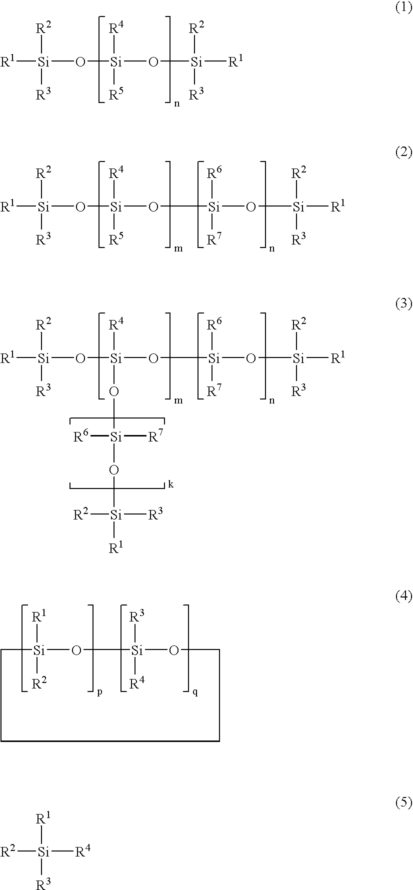

wherein R¹ to R⁷ are each independently a hydrogen atom, hydroxyl group, hydrolyzable group or monovalent hydrocarbon group, with the proviso that in each of the compounds of formulae (1) to (5), at least two silicon-bonded substituent groups are hydrogen atoms, hydroxyl groups, hydrolyzable groups or aliphatic unsaturated hydrocarbon groups, m, n and k each are a number of 0 to 2,000, p and q each are a number of 0 to 10, p and q are not equal to 0 at the same time.

In a preferred embodiment, the reactive silane or siloxane is derived from a silane or siloxane having the average formula: C_{w}HₓSiO_{y}N_{z} wherein w and x are positive numbers, y and z are 0 or positive numbers, and (w−y) is greater than 0, and including at least one crosslinkable site per four silicon atoms.

The method may further comprise, after the addition of metallic lithium or organolithium compound, reducing it for lithiation, and grinding the composite to an average particle size of 0.1 to 30 μm.

Also provided is a method for preparing a surface conductive SiCO—Li composite, comprising the step of depositing carbon on the surface of the SiCO—Li composite prepared by the above-described method through CVD.

In a further aspect, the invention provides a negative electrode material for use in a non-aqueous electrolyte secondary cell, comprising the inventive SiCO—Li composite; or a negative electrode material for use in a non-aqueous electrolyte secondary cell, comprising a mixture of the inventive SiCO—Li composite and a conductive agent, the mixture containing 5 to 60% by weight of the conductive agent and having a total carbon content of 5 to 90% by weight.

### BENEFITS OF THE INVENTION

The SiCO—Li composite of the invention exhibits a satisfactory initial efficiency, satisfactory cycle performance, and unique discharge characteristics, when used as the negative electrode material for non-aqueous electrolyte secondary cells.

### BRIEF DESCRIPTION OF THE DRAWINGS

FIG. 1 is a X-ray diffraction diagram of the SiCO—Li composite (prior to CVD carbon coating) of Example 1.

FIG. 2 is a X-ray diffraction diagram of the SiCO—Li composite (prior to CVD carbon coating) of Example 2.

FIG. 3 is a graph showing first and second charge/discharge curves of the SiCO—Li composite of Example 1.

### DESCRIPTION OF THE PREFERRED EMBODIMENTS

As used herein, the term “conductive” refers to electrical conduction.

For use as the lithium ion secondary cell negative electrode active material, a siliceous material is expected promising because of its charge/discharge capacity which is several times greater than that of the current mainstream graphite-derived materials, but is prevented from practical use by the degradation of performance due to a substantial volume change associated with adsorption and desorption of lithium and a failure of electrode film with repeated charge/discharge operation. While the Si—C—O composite has improved the cycle performance and efficiency over the siliceous material, the present invention relates to a SiCO—Li composite which overcomes the initial efficiency drawback of the Si—C—O composite. The SiCO—Li composite has a network of silicon bound by robust Si—C bonds and silicon capable of adsorption and desorption of lithium and is arrived at by curing a reactive silane or siloxane containing a high level of crosslinkable groups or a mixture thereof through heat curing or catalytic reaction into a highly crosslinked product, sintering the crosslinked product in an inert gas stream at a temperature in the range of 700 to 1,400° C. into an inorganic state, adding metallic lithium and/or an organolithium compound to the sintered product for doping it with lithium. Lithium doping is referred to as lithiation. To enhance conductivity within the particle interior, conductive carbon, graphite or the like may be added to the silane or siloxane. Further preferably, particles are surface coated or covered with carbon such that carbon is fused to at least part of the particle surface.

As used herein, the term silane or siloxane “containing a high level of crosslinkable groups” means that the compound has, on the average, at least one, preferably at least two, and more preferably at least 2.5 crosslinkable groups per ten silicon atoms, and specifically that the compound has a combination of SiH groups with aliphatic unsaturated groups (e.g., alkenyl, alkynyl groups) which can form a crosslinked structure through hydrosilylation reaction, a combination of silicon-bonded hydroxyl groups (silanol groups) and/or organoxy groups (e.g., alkoxy groups) with silicon-bonded hydrolyzable groups (e.g., alkoxy, acyloxy, alkenyloxy and ketoxime or iminoxy groups) which can form a crosslinked structure through condensation reaction, silicon-bonded alkenyl groups which can form a crosslinked structure through radical reaction, typically reaction with the aid of organic peroxides, (meth)acryloxy functional groups which can form a crosslinked structure through photochemical reaction, typically UV-initiated reaction, or a combination of mercapto functional groups with alkenyl groups.

The term “highly crosslinked product” refers to a cured or crosslinked product resulting from heat curing or catalytic reaction of the reactive silane or siloxane containing a high level of crosslinkable groups or mixture thereof.

The SiCO—Li composite of the invention should preferably meet the following conditions.

i) The SiCO—Li composite has the general formula: LiₚSiCₙOₘ wherein p, m and n each are positive numbers and preferably satisfy p/m≦2 and 0<n≦10.
ii) On X-ray diffraction analysis, the composite is found to be amorphous or substantially amorphous, except that diffraction lines ascribable to additives such as graphite are observable.

The organosilicon compound (silane and siloxane) from which the Si—C—O composite, i.e., precursor to the SiCO—Li composite of the invention is prepared may be any organosilicon compound having at least two crosslinkable functional groups bonded to silicon atoms in the molecule, for example, aliphatic unsaturated groups (e.g., alkenyl groups), hydroxyl groups, hydrogen atoms (SiH groups) or hydrolyzable groups, alone or in combination of two or more compounds. The organosilicon compounds may be straight, branched or cyclic, and specifically, include straight organopolysiloxanes having the general formulae (1) and (2), branched organopolysiloxanes having the general formula (3), cyclic organopolysiloxanes having the general formula (4), and silane or silicone resins having the general formula (5), shown below.

The preferred organosilicon compounds are liquid at room temperature (25° C.). Solid organosilicon compounds as typified by silicone resins are also acceptable as long as they have a softening point. Alternatively, the organosilicon compounds may be diluted with organic solvents in which the organosilicon compounds are dissolvable or non-reactive silicone oils. Suitable organic solvents include hexane, toluene and xylene, and a typical non-reactive silicone oil is dimethylpolysiloxane oil. While powdered silicones are available in pre-crosslinked form, those having a highly crosslinked structure are also useful herein.

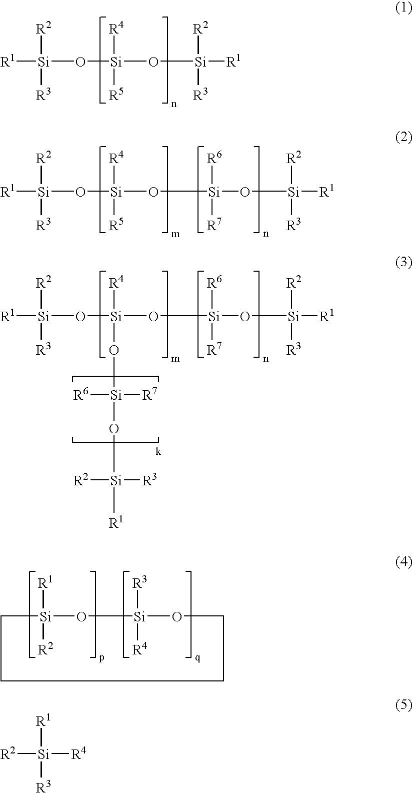

In the formulae, R¹ to R⁷ are each independently a hydrogen atom, hydroxyl group, hydrolyzable group or monovalent hydrocarbon group. In each of the compounds of formulae (1) to (5), at least two of substituent groups attached to silicon atoms are hydrogen atoms, hydroxyl groups, hydrolyzable groups or aliphatic unsaturated hydrocarbon groups. Preferred hydrolyzable groups include alkoxy, alkenyloxy, and acyloxy groups having 1 to 6 carbon atoms. Preferred monovalent hydrocarbon groups include those of 1 to 12 carbon atoms, more preferably 1 to 8 carbon atoms, for example, alkyl, alkenyl, alkynyl, aryl and aralkyl groups. Included are alkyl groups such as methyl, ethyl, propyl, butyl, and hexyl, alkenyl groups such as vinyl, allyl, butenyl, hexenyl and cyclohexenyl, alkynyl groups such as ethynyl, propynyl, butynyl and hexynyl, aryl groups such as phenyl and tolyl, and aralkyl groups such as benzyl and phenylethyl.

The subscripts m, n and k are numbers of 0 to 2,000, preferably 0 to 1,000, p and q are numbers of 0 to 10, p and q are not equal to 0 at the same time. Preferably p+q is from 3 to 10.

The crosslinkable organosilicon compounds, silanes and siloxanes are not particularly limited as long as they are generally used in the manufacture of silicones. Usually, a chain-like polymer of an organosilicon compound such as an organic siloxane polymer, when heated in a non-oxidizing gas stream, readily undergoes thermal cleavage on its main chain bonds and decomposes into low-molecular-weight components (e.g., cyclic oligomers of 3 to 6 monomer units) which will volatilize off. In contrast, silicon-carbon bonds formed by hydrosilylation reaction, for example, are resistant to heat. Then, for highly crosslinked products resulting from hydrosilylation, decomposition into low-molecular-weight components is less likely to occur, and even if occurs, the resulting substances are less volatile due to a high degree of crosslinking. This ensures effective conversion into an inorganic state during the firing step without volatilization. Among the silanes or siloxanes having the general formulae (1) to (5), an addition reaction curing organopolysiloxane composition is preferably used comprising a silane and/or siloxane having preferably at least 2, more preferably at least 3, even more preferably 4 to 2,000 SiH groups within the molecule and a siloxane having preferably at least 2, more preferably at least 3, even more preferably 4 to 50 aliphatic unsaturated groups (such as alkenyl and alkynyl groups) within the molecule and containing preferably at least 2, more preferably 2.5 to 10 aliphatic unsaturated groups per ten silicon atoms wherein hydrosilylation reaction takes place in the presence of a well-known hydrosilylation catalyst such as platinum or a platinum compound within graphite to form a crosslinked product.

Specifically, the preferred reactive silane or siloxane is a combination of a silane and/or siloxane having at least two SiH groups in a molecule with a siloxane having at least two aliphatic unsaturated groups in a molecule and containing at least two aliphatic unsaturated groups per ten silicon atoms, which combination undergoes hydrosilylation reaction in the presence of a hydrosilylation catalyst to form a crosslinked product.

This reaction is preferably carried out at a molar ratio of SiH groups to aliphatic unsaturated groups which ranges from 0.8 to 2, especially from 0.9 to 1.2. The amount of the hydrosilylation catalyst added may be a catalytic amount which is typically about 5 to 1,000 ppm, preferably about 10 to 200 ppm, calculated as the weight of platinum based on the total weight of the crosslinkable silanes and siloxanes. The reaction (or curing) temperature is preferably from room temperature (25° C.) to 300° C., more preferably 60 to 200° C. The reaction (or curing) time is usually about 5 minutes to about one hour.

It is also preferred to use a silicone resin having hydrolyzable groups such as hydroxyl, alkoxy or acyloxy groups within the molecule, which can condense through catalytic reaction or non-catalytic reaction into a highly crosslinked product. Examples of the catalyst, if used, include well-known condensation catalysts for condensation curing organopolysiloxane compositions, for example, organotin compounds such as dialkyltin diorganic acids.

The other preferred organosilicon compound (silane or siloxane or mixture) used herein is of the average compositional formula:

C_{w}HₓSiO_{y}N_{z}

wherein w and x are positive numbers, y and z are 0 or positive numbers, and w−y>0, and has at least one crosslinkable site per four silicon atoms. Nitrogen may be bonded to silicon directly or indirectly via carbon or the like.

In preparing the SiCO—Li composite of the invention, a carbonaceous material and/or silicon may be added to the organosilicon compound as a conductive material and/or lithium-occluding material. Although the characteristics of the carbonaceous material to be added are not particularly limited, preference is given to spherical or flake particles of graphite commonly used as the lithium ion secondary cell negative electrode material.

The amount of the carbonaceous material added is 1 to 80% by weight, preferably 5 to 80% by weight, more preferably 5 to 70% by weight, even more preferably 10 to 50% by weight, based on the total weight of the organosilicon compound or mixture thereof and the carbonaceous material. Less than 5 wt % of the carbonaceous material may fail to impart sufficient conductivity whereas more than 80 wt % may lead to a reduced capacity. It is noted that the capacity of a non-aqueous electrolyte secondary cell negative electrode material comprising the inventive SiCO—Li composite is determined from the capacity of graphite alone and the capacity of the SiCO—Li composite and the mixing ratio therebetween. This means that as the amount of low-capacity graphite material added increases, the capacity decreases (although the initial efficiency is not affected). The siliceous materials which are expected to achieve a capacity improvement include metallic silicon, silicon for semiconductor use, and polycrystalline silicon in powder form.

In the embodiment wherein particulate graphite and/or powdered silicon is added, particles are advantageously surface treated with an organosilicon surface treating agent or agents for improving the adhesion between additive particles and the SiCO—Li composite. The surface treating agent is selected from the group consisting of silane coupling agents, (partial) hydrolytic condensates thereof, silylating agents, and silicone resins, as represented by formulae (6) to (8). It is noted that the (partial) hydrolytic condensates refers to hydrolytic condensates or partial hydrolytic condensates.

R⁸₍₄₋ₐ₎Si(Y)ₐ (6)

R⁸_{b}Si(Z)_{(4-b)/2} (7)

R⁹_{c}(R¹⁰O)_{d}SiO_{(4-c-d)/2} (8)

R⁸ is a monovalent organic group, Y is a monovalent hydrolyzable group or hydroxyl group, Z is a divalent hydrolyzable group, a is an integer of 1 to 4, b is a positive number of 0.8 to 3, preferably 1 to 3; R⁹ is hydrogen or a substituted or unsubstituted monovalent hydrocarbon group of 1 to 10 carbon atoms, R¹⁰ is hydrogen or a substituted or unsubstituted monovalent hydrocarbon group of 1 to 6 carbon atoms, c and d are 0 or positive numbers satisfying 0≦c≦2.5, 0.01≦d≦3, and 0.5≦c+d≦3.

Examples of R⁸ include unsubstituted monovalent hydrocarbon groups, such as alkyl, cycloalkyl, alkenyl, aryl and aralkyl groups of 1 to 12 carbon atoms, preferably 1 to 10 carbon atoms; substituted monovalent hydrocarbon groups in which some or all of the hydrogen atoms on the foregoing groups are replaced by functional groups such as halogen atoms (e.g., chloro, fluoro, bromo), cyano, oxyalkylene (e.g., oxyethylene), polyoxyalkylene (e.g., polyoxyethylene), (meth)acrylic, (meth)acryloxy, acryloyl, methacryloyl, mercapto, amino, amide, ureido, and epoxy groups; and the foregoing substituted or unsubstituted monovalent hydrocarbon groups which are separated by an oxygen atom, NH, NCH₃, NC₆H₅, C₆H₅NH—, H₂NCH₂CH₂NH— or similar group.

Illustrative examples of R⁸ include alkyl groups such as CH₃—, CH₃CH₂—, CH₃CH₂CH₂—, alkenyl groups such as CH₂═CH—, CH₂═CHCH₂—, CH₂═C(CH₃)—, aryl groups such as C₆H₅—, ClCH₂—, ClCH₂CH₂CH₂—, CF₃CH₂CH₂—, CNCH₂CH₂—, CH₃—(CH₂CH₂O)ₛ—CH₂CH₂CH₂— wherein s is an integer of 1 to 3, CH₂(O)CHCH₂OCH₂CH₂CH₂— wherein CH₂(O)CHCH₂ stands for glycidyl, CH₂═CHCOOCH₂—,

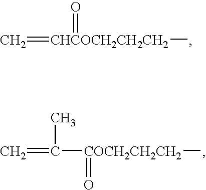

HSCH₂CH₂CH₂—, NH₂CH₂CH₂CH₂—, NH₂CH₂CH₂NHCH₂CH₂CH₂—, NH₂CONHCH₂CH₂CH₂—, etc. Preferred examples of R⁸ include γ-glycidyloxypropyl, β-(3,4-epoxycyclohexyl)ethyl, γ-aminopropyl, γ-cyanopropyl, γ-acryloxypropyl, γ-methacryloxypropyl, and γ-ureidopropyl.

The monovalent hydrolyzable groups represented by Y include alkoxy groups such as —OCH₃, —OCH₂CH₃, amino groups such as —NH₂, —NH—, —N═, —N(CH₃)₂, —Cl, oxyimino groups such as —ON═C(CH₃)CH₂CH₃, aminooxy groups such as —ON(CH₃)₂, carboxyl groups such as —OCOCH₃, alkenyloxy groups such as —OC(CH₃)═CH₂, —CH(CH₃)—COOCH₃, —C(CH₃)₂—COOCH₃, etc. The groups of Y may be the same or different. Preferred examples of Y include alkoxy groups such as methoxy and ethoxy, and alkenyloxy groups such as isopropenyloxy.

The divalent hydrolyzable groups represented by Z include imide residues (—NH—), substituted or unsubstituted acetamide residues, urea residues, carbamate residues, and sulfamate residues.

The subscript “a” is an integer of 1 to 4, preferably 3 or 4, b is a positive number of 0.8 to 3, preferably 1 to 3.

The monovalent hydrocarbon group represented by R⁹ are the same as the monovalent hydrocarbon groups of 1 to 10 carbon atoms exemplified above for R¹ to R⁷. The monovalent hydrocarbon group represented by R¹⁰ are the same as the monovalent hydrocarbon groups of 1 to 6 carbon atoms exemplified above for R¹ to R⁷.

The subscripts c and d are 0 or positive numbers satisfying 0≦c≦2.5, 0.01≦d≦3, and 0.5≦c+d≦3, and preferably 1≦c≦2, 1≦d≦2, and 2≦c+d≦3.

Illustrative examples of the silane coupling agents include methyltrimethoxysilane, tetraethoxysilane, vinyltrimethoxysilane, methylvinyldimethoxysilane, γ-aminopropyltriethoxysilane, γ-mercaptopropyltrimethoxysilane, γ-cyanopropyltrimethoxysilane, N-β-(aminoethyl)-γ-aminopropyltrimethoxysilane, γ-methacryloxypropyltrimethoxysilane, γ-glycidyloxypropyltrimethoxysilane, β-(3,4-epoxycyclohexyl)ethyltrimethoxysilane, and γ-ureidopropyltrimethoxysilane. The silane coupling agents may be used alone or in admixture of two or more. Hydrolytic condensates and/or partial hydrolytic condensates of these silanes are also acceptable.

Illustrative examples of the silylating agents having formula (7) include organosilazanes such as hexamethyldisilazane, divinyltetramethyldisilazane, tetravinyldimethyldisilazane, and octamethyltrisilazane, N,O-bis(trimethylsilyl)acetamide, N,O-bis(trimethylsilyl)carbamate, N,O-bis(trimethylsilyl)sulfamate, N,O-bis(trimethylsilyl)trifluoroacetamide, and N,N′-bis(trimethylsilyl)urea. Of these, divinyltetramethyldisilazane is most preferred.

The surface treating agent is typically used in an amount of 0.1 to 10% by weight, preferably 1 to 5% by weight, more preferably 1 to 3% by weight based on the weight of graphite and/or silicon powder.

The SiCO—Li composite powder (particles) of the invention may be surface-coated with carbon. The amount of carbon coated or vapor deposited on the SiCO—Li composite powder is preferably 1 to 50% by weight, more preferably 5 to 30% by weight and even more preferably 5 to 20% by weight based on the SiCO—Li composite powder (i.e., SiCO—Li composite powder which has been surface coated with a conductive coating by thermal CVD). If the amount of carbon coated or deposited is less than 1 wt %, the SiCO—Li composite powder used alone as a negative electrode active material forms a negative electrode film having less than desired conductivity, indicating that the carbon coating is meaningless. If the amount of carbon coated or deposited is more than 50 wt %, indicating a too large proportion of carbon, the negative electrode capacity may be reduced, detracting from the benefits of the invention.

The SiCO—Li composite particles (containing voids within themselves) preferably have a void content of 1 to 70% by volume, especially 10 to 50% by volume. A void content of less than 1% by volume may lead to the increased risk that particles collapse by volume changes during charge/discharge operation. A void content of more than 70% by volume may lead to a reduced capacity or liquid electrolyte leakage. The void content is computed from a specific gravity.

The SiCO—Li composite particles preferably have an average particle size of 0.5 to 50 μm, more preferably 5 to 20 μm, in view of formation of a negative electrode film and cycle performance when the particles are used as negative electrode material for lithium ion secondary cells. It is noted that the average particle size is determined as a weight average diameter D₅₀ (particle diameter at 50% by weight cumulative, or median diameter) upon measurement of particle size distribution by laser light diffractometry.

Now, it is described how to prepare the SiCO—Li composite particles of the invention.

According to the invention, SiCO—Li composite particles are prepared by curing a reactive organosilicon compound having crosslinkable groups or a mixture thereof through heat curing or catalytic reaction into a crosslinked product and sintering the crosslinked product in an inert gas stream at a temperature in the range of 700 to 1,400° C., preferably 800 to 1,300° C., more preferably 900 to 1,200° C. into an inorganic state. Otherwise, the preparation method is not particularly limited. The preferred preparation method of the invention includes the following stages I to IV.

### Stage I:

Surfaces of additive particles, typically graphite and/or silicon particles which have been sized to have an average particle size of 1 to 20 μm, preferably 3 to 10 μm, are pretreated with at least one organosilicon surface treating agent selected from among the above-described silane coupling agents, (partial) hydrolytic condensates, silylating agents, and silicone resins, for the purpose of enhancing the adhesion between the graphite and/or silicon particles and the organosilicon compound or mixture thereof, thereby improving cycle performance.

### Stage II:

The organosilicon compound or mixture thereof, especially an addition curing organopolysiloxane composition comprising a vinylsiloxane, hydrogensiloxane and platinum catalyst, to which graphite and/or silicon particles obtained in Stage I are optionally added and thoroughly mixed together, is pre-cured at a temperature of 300° C. or lower, preferably 60 to 200° C. If necessary, an organic solvent is added to help form a uniform mixture. The precuring atmosphere is not particularly limited.

At this stage, the pre-cured product may be pulverized to a particle size of 0.1 to 30 μm, preferably 1 to 20 μm, for facilitating the subsequent pulverizing and sizing. Although the pulverizing technique is not particularly limited, pulverization in a dispersing medium is recommended because of the likelihood of electrostatic charges accumulating during the pulverization at this stage. The preferred dispersing media are organic solvents including hexane, toluene, methanol, methyl isobutyl ketone, dibutyl ether and isobutyl acetate, but not limited thereto.

Of silicone fine powders available in spherical microparticulate silicone form, highly crosslinked silicone powders may also be used as the starting material.

### Stage III:

The pre-cured product is heat treated in an inert gas atmosphere at a temperature in the range of 700 to 1,400° C., preferably 800 to 1,300° C., more preferably 900 to 1,200° C., yielding Si—C—O(C) composite containing voids in the interior. As used herein, Si—C—O(C) composite means Si—C—O composite having graphite and/or silicon powder added thereto. Thereafter, the Si—C—O(C) composite is again pulverized and sized to a particle size of 0.1 to 30 μm, preferably 1 to 20 μm, yielding Si—C—O(C) composite particles. Any desired pulverizing technique may be employed. The inert gas atmosphere may be nitrogen, argon or the like.

### Stage IV:

To the Si—C—O(C) composite particles obtained in Stage III in an inert atmosphere, metallic lithium and/or an organolithium compound is added for doping, i.e., lithiation. Metallic lithium used herein is available in mass, powder or foil form, and its form is not important. The organolithium compounds include alkyllithium such as butyllithium and aryllithium such as phenyllithium, and their form is not particularly limited.

Lithiation is carried out, for example, by adding a predetermined amount of metallic lithium powder, foil or mass to the Si—C—O composite particles in an inert atmosphere, and mixing in a device capable of applying high shear stresses such as a ball mill for inducing the reaction. When the organolithium compound is used, lithiation is carried out, as is known for the lithiation of general particles, by dispersing the Si—C—O composite particles in an organic solvent such as toluene, adding the organolithium compound to the dispersion, and mixing under high shear stresses for inducing the reaction.

In Stage II, if a mixture of reactive vinylsiloxane and hydrogensiloxane containing a hydrosilylation catalyst such as platinum catalyst, optionally combined with graphite and/or silicon particles, is directly heated to a firing temperature in the elevated range without precuring at temperatures below 300° C., formation of low-molecular-weight siloxanes and cracking of siloxanes become predominant, resulting in increased losses.

In Stage III, a heat treatment temperature below 700° C. induces insufficient conversion of cured siloxane into an inorganic state, leading to a lowering of initial efficiency and cycle performance. A heat treatment temperature above 1,400° C. forces further conversion to silicon carbide SiC which is inactive as the lithium ion secondary cell negative electrode material, giving rise to unwanted problems with respect to cell operation.

In Stage IV, abrupt exothermic reaction occurs particularly when metallic lithium is added. A reactor or mixer designed for effective heat dissipation must be used. When the organolithium compound is added, the reactor should additionally be designed for discharge of decomposed product vapor.

The rate-determining step of lithiation reaction is diffusion of lithium into the solid Si—C—O composite. If unreacted lithium is left behind, it is undesirable in both property and safety aspects. Then the reaction should be controlled such that the amount of metallic lithium added is Li/O<2 and lithium is uniformly distributed.

It is thus preferred that the Si—C—O composite to be lithiated be fed in powder form. While metallic lithium is generally available in powder, foil or mass form, the use of powder form, for example, stabilized lithium powder SLMP (FMC Corp.) is preferred.

More particularly, the Si—C—O composite and the lithiating agent (i.e., metallic lithium) both having the desired particle size distribution are premixed in an inert gas atmosphere and mechanically mixed for reaction in a mixer with an effective heat dissipation capability. If mixing is performed in a short heat dissipating state, for example, relatively large amounts are mixed in an iron mortar, the mixture initiates reaction abruptly, creating an ignited state. Once reaction occurs in this way, silicon grows into large crystals due to abrupt disproportionation. Inversely, a layer of lithium silicate remaining as an oxygen compound becomes so thick that it acts as an insulator to reduce a current collecting capability, eventually inviting a drop of capacity. For this reason, the abrupt reaction should be avoided.

The reactor used should be sealed with an inert gas, designed for effective heat dissipation (because significant exothermic reaction occurs therein), and capable of mixing under high shear stresses. No other limits are imposed on the reactor. One exemplary compact reactor is a planetary ball mill featuring a tight closure, potential heat dissipation of balls, and high shear stresses.

Mixing/reaction is carried out in a device which applies high shear stresses in an inert gas atmosphere and provides for effective heat dissipation. One exemplary compact reactor is a planetary ball mill. In one exemplary procedure, predetermined amounts of metallic lithium and silicon oxide and/or silicon oxide-based material are weighed in a globe box under an argon blanket. They are premixed and fed into a jar of a planetary ball mill together with a predetermined number of balls, which is tightly closed. The jar is then mounted on the planetary ball mill, which is operated for milling and reaction for a predetermined time. The key features in the course of reaction for determining the characteristics of the product include the heat release, heat transfer, and shear stress, and the characteristics of the product vary with the charge, rotational speed and/or milling time. These parameters are determined by carrying out a preliminary test and analyzing the characteristics of the test product by X-ray diffractometry or the like.

The reaction is a solid reaction between the solid Si—C—O composite and metallic lithium (or can be a solid-liquid reaction in the event metallic lithium melts during reaction). However, since the rate of diffusion into a solid is generally low, it is difficult for metallic lithium to penetrate uniformly into the fully solid siliceous material such as silicon oxide. It is then necessary for safety sake that the amount of metallic lithium added is controlled at a relatively low level rather than to supplement the overall irreversible capacity. One effective approach for complementing this shortage is by adding an organolithium compound (e.g., alkyllithium or aryllithium) to complement a lithium value after the addition and reaction of metallic lithium. This approach is effective for complementing a shortage because a consideration for the removal of decomposed products is otherwise necessary.

After Stage IV of lithiation, the SiCO—Li composite is preferably pulverized again to an average particle size of 0.1 to 30 μm, preferably 1 to 20 μm.

The SiCO—Li composite particles obtained in Stage IV may be heat treated in an atmosphere containing an organic matter gas and/or vapor at a temperature in the range of 700 to 1,300° C., preferably 800 to 1,200° C., more preferably 900 to 1,150° C., for chemical vapor deposition (CVD) on the particle surfaces.

The organic material to generate the organic matter gas is selected from those materials capable of producing carbon (graphite) through pyrolysis at the heat treatment temperature, especially in a non-oxidizing atmosphere. Exemplary are hydrocarbons such as methane, ethane, ethylene, acetylene, propane, butane, butene, pentane, isobutane, and hexane alone or in admixture of any, and monocyclic to tricyclic aromatic hydrocarbons such as benzene, toluene, xylene, styrene, ethylbenzene, diphenylmethane, naphthalene, phenol, cresol, nitrobenzene, chlorobenzene, indene, coumarone, pyridine, anthracene, and phenanthrene alone or in admixture of any. Also, gas light oil, creosote oil and anthracene oil obtained from the tar distillation step are useful as well as naphtha cracked tar oil, alone or in admixture.

For the thermal CVD (thermal chemical vapor deposition), any desired reactor having a heating mechanism may be used in a non-oxidizing atmosphere. Depending on a particular purpose, a reactor capable of either continuous or batchwise treatment may be selected from, for example, a fluidized bed reactor, rotary furnace, vertical moving bed reactor, tunnel furnace, batch furnace and rotary kiln. The treating gas used herein may be the aforementioned organic matter gas alone or in admixture with a non-oxidizing gas such as Ar, He, H₂ or N₂.

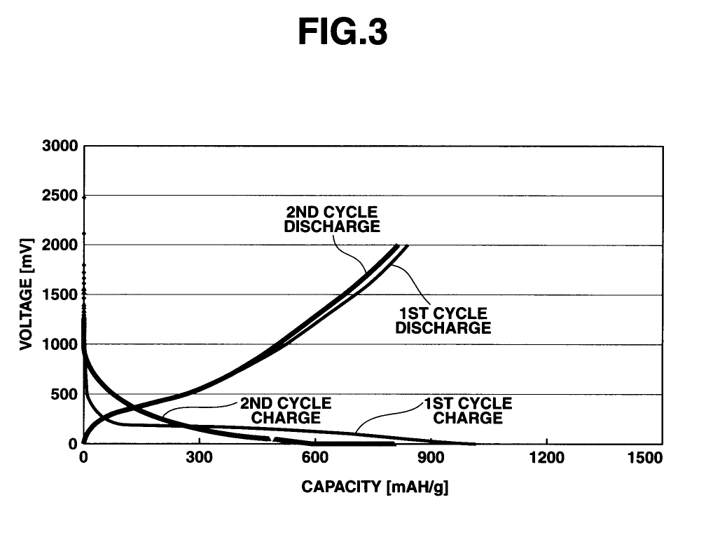

According to the invention, the SiCO—Li composite powder may be used as a negative electrode material, specifically a negative electrode active material to construct a non-aqueous electrolyte secondary cell, especially a lithium ion secondary cell, having a high capacity and improved cycle performance as well as unique discharge characteristics as illustrated in FIG. 3.

When a negative electrode is prepared using the inventive SiCO—Li composite powder, a conductive agent such as graphite may be added to the powder. The type of conductive agent used herein is not particularly limited as long as it is an electronically conductive material which does not undergo decomposition or alteration in the cell. Illustrative conductive agents include metals in powder or fiber form such as Al, Ti, Fe, Ni, Cu, Zn, Ag, Sn and Si, natural graphite, synthetic graphite, various coke powders, meso-phase carbon, vapor phase grown carbon fibers, pitch base carbon fibers, PAN base carbon fibers, and graphite obtained by firing various resins.

The conductive agent is not always necessary if the composite powder has been combined with graphite and/or coated with carbon by thermal CVD. If the powder has not been so treated or coated, the amount of conductive agent added is preferably 5 to 60% by weight, more preferably 10 to 50% by weight, even more preferably 20 to 40% by weight of the negative electrode-forming mixture of SiCO—Li composite powder plus conductive agent. A mixture with less than 5 wt % of the conductive agent may form a less conductive electrode film, whereas a mixture with more than 60 wt % of the conductive agent may have a reduced charge/discharge capacity.

The total amount of carbon in the negative electrode-forming mixture of SiCO—Li composite powder plus conductive agent is preferably 5 to 90% by weight, more preferably 5 to 70% by weight, even more preferably 10 to 50% by weight. A mixture with less than 5 wt % of carbon may lead to poor conductivity or the increased risk of particles collapsing by volume changes, whereas a mixture with more than 90 wt % of carbon may have a reduced capacity.

Using the negative electrode thus obtained, a lithium ion secondary cell can be fabricated. The lithium ion secondary cell thus constructed is characterized by the use of the SiCO—Li composite as the negative electrode active material while the materials of the positive electrode, electrolyte, and separator and the cell design are not critical. For example, the positive electrode active material used herein may be selected from transition metal oxides such as LiCoO₂, LiNiO₂, LiMn₂O₄, V₂O₅, MnO₂, TiS₂ and MoS₂ and chalcogen compounds. The electrolytes used herein may be lithium salts such as lithium perchlorate in non-aqueous solution form. Examples of the non-aqueous solvent include propylene carbonate, ethylene carbonate, dimethoxyethane, γ-butyrolactone and 2-methyltetrahydrofuran, alone or in admixture. Use may also be made of other various non-aqueous electrolytes and solid electrolytes.

### EXAMPLE

Examples of the invention are given below by way of illustration and not by way of limitation. In Examples, all percents are by weight. The average particle size is determined as a cumulative weight average diameter D₅₀ (or median diameter) upon measurement of particle size distribution by laser light diffractometry.

### Example 1

To a curable siloxane mixture of 120 grams (g) of tetramethyltetravinylcyclotetrasiloxane (LS-8670, Shin-Etsu Chemical Co., Ltd.) and 80 grams (g) of methylhydrogensiloxane (KF-99, Shin-Etsu Chemical Co., Ltd.) was added 0.1 g of a chloroplatinic acid catalyst (1% chloroplatinic acid solution). The mixture was thoroughly mixed and precured at 60° C. for one day. The precured mixture in mass form was placed in a glass container and further in an atmosphere-controllable, temperature-programmable muffle furnace where it was heated in a nitrogen atmosphere at 200° C. for 2 hours until it was fully cured. The cured product was crushed and then milled in a ball mill, using hexane as a dispersing medium, to an average particle size of 10 μm. Then the powder was placed in a lidded alumina container and fired in an atmosphere-controllable, temperature-programmable muffle furnace in a nitrogen atmosphere at 1,000° C. for 3 hours. After cooling, the fired product was pulverized on a grinder (Masscolloider) with a set clearance of 20 μm, yielding Si—C—O composite powder having an average particle size of about 10 μm.

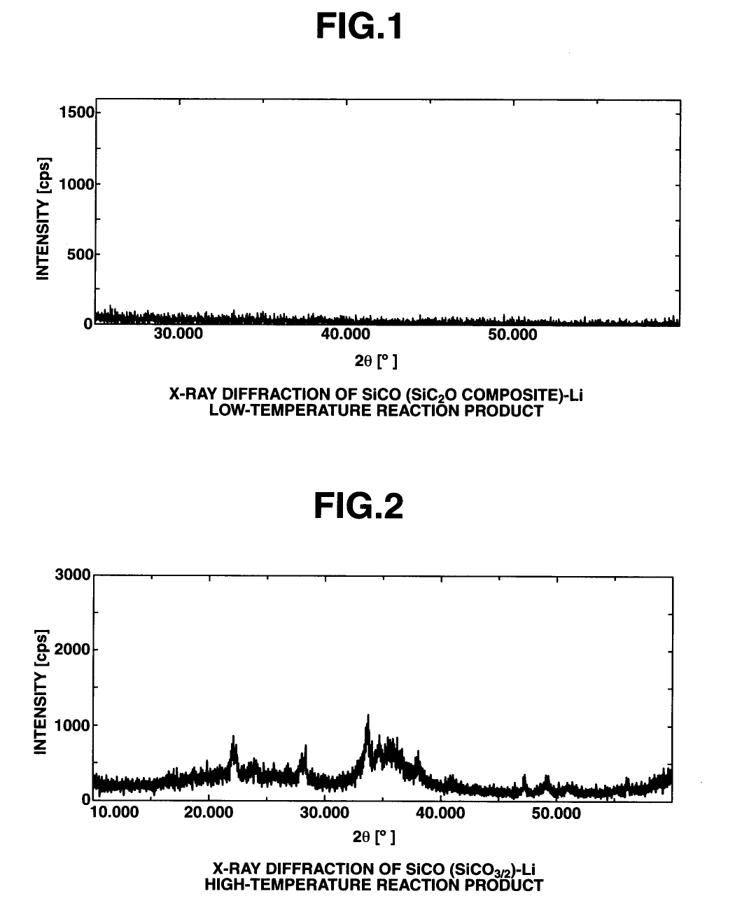

In a globe box under an argon blanket, a portion (8.5 g) of the Si—C—O composite powder was weighed and placed in a glass vial with an internal volume of about 50 ml. Stabilized lithium powder SLMP (FMC Corp.), 1.5 g, was added to the vial, which was closed with a cap and manually shaken for mixing. The mixture was transferred to a 500-ml stainless steel jar of a planetary ball mill PM-100 (Retsch GmbH), containing ten stainless steel balls of each 32 g. The jar was closed, taken out of the globe box, and mounted in place on the planetary ball mill PM-100. The jar was rotated at a rotational speed of 500 rpm in forward and backward directions each for 10 minutes. The jar was allowed to cool, after which the silicon-silicon oxide-lithium composite was taken out. It was analyzed by X-ray diffractometry, with the data shown in FIG. 1, demonstrating that the composite was amorphous.

Using a vertical tubular furnace (inner diameter ˜50 mm), the composite powder was subjected to thermal CVD in a methane-argon mixture stream at 1,100° C. for 3 hours. The black mass thus obtained was disintegrated in an automated mortar. The carbon-coated SiCO—Li composite powder had a surface coating carbon content of 14% and an average particle size of 13 μm. That is, CVD by 1100° C./3 hr contact with methane-argon gas mixture produced a carbon coat of about 14%.

### Cell Test

The evaluation of composite powder as the negative electrode active material for a lithium ion secondary cell was carried out by the following procedure which was common to all Examples and Comparative Examples.

First, a polyimide resin varnish Rikacoat SN-20 (New Japan Chemical Co., Ltd.) was added in an amount of 15% as solids to 85 g of a siliceous negative electrode material (SiCO—Li composite in Examples) to form a slurry below 20° C. Further N-methylpyrrolidone was added for viscosity adjustment. Immediately thereafter, the slurry was coated onto a copper foil of 20 μm thick and dried at 120° C. for one hour. Using a roller press, the coated foil was shaped under pressure into an electrode sheet, of which 2 cm² discs were punched out as the negative electrode.

Using the negative electrode, a test lithium ion secondary cell was constructed. The lithium ion secondary cell was allowed to stand overnight at room temperature. Using a secondary cell charge/discharge tester (Nagano K.K.), a charge/discharge test was carried out on the cell. Charging was conducted with a constant current flow of 3 mA until the voltage of the test cell reached 0 V, and after reaching 0 V, continued with a reduced current flow so that the cell voltage was kept at 0 V, and terminated when the current flow decreased below 100 μA. Discharging was conducted with a constant current flow of 3 mA and terminated when the cell voltage rose above 2.0 V, from which a discharge capacity was determined.

By repeating the above operations, the charge/discharge test on the lithium ion secondary cell was carried out 50 cycles. The results are shown in Table 1. FIG. 3 shows the charge/discharge curves of 1st and 2nd cycles.

### Example 2

A silicone powder X-52-1621 (Shin-Etsu Chemical Co., Ltd.) which is a spherical, trifunctional, highly crosslinked methylsiloxane polymer of the general formula: (CH₃SiO_{3/2})ₙ and has an average particle size of about 10 μm was placed in a lidded alumina container. The container was placed in an atmosphere-controllable, temperature-programmable muffle furnace where the powder was fired in a nitrogen atmosphere at 1,000° C. for 3 hours. After cooling, the fired product was pulverized on a grinder (Masscolloider) with a set clearance of 20 μm, yielding Si—C—O composite powder having an average particle size of about 10 μm.

In a globe box under an argon blanket, a portion (17.0 g) of the Si—C—O composite powder was weighed and placed in a glass vial with an internal volume of about 50 ml. Stabilized lithium powder SLMP (FMC Corp.), 3.0 g, was added to the vial, which was closed with a cap and manually shaken for mixing. The mixture was transferred to a 500-ml stainless steel jar of a planetary ball mill PM-100 (Retsch GmbH), containing ten stainless steel balls of each 32 g. The jar was closed, taken out of the globe box, and mounted in place on the planetary ball mill PM-100. The jar was rotated at a rotational speed of 500 rpm in forward and backward directions each for 10 minutes. The jar was allowed to cool, after which the silicon-silicon oxide-lithium composite was taken out. It was analyzed by X-ray diffractometry, with the data shown in FIG. 2. The composite was substantially amorphous with a little crystallinity observed.

Using a vertical tubular furnace (inner diameter ˜50 mm), the composite powder was subjected to thermal CVD in a methane-argon mixture stream at 1,100° C. for 3 hours. The black mass thus obtained was disintegrated in an automated mortar. The carbon-coated SiCO—Li composite powder had a surface coating carbon content of 15% and an average particle size of 11 μm.

As in Example 1, the carbon-coated SiCO—Li composite powder was evaluated as the negative electrode active material for a lithium ion secondary cell. The results are shown in Table 1.

### Example 3

To 50 g of naturally occurring flake graphite having an average particle size of 6 μm was added a curable siloxane mixture consisting of 120 g of tetramethyltetravinylcyclotetrasiloxane (LS-8670, Shin-Etsu Chemical Co., Ltd.), 80 g of methylhydrogensiloxane (KF-99, Shin-Etsu Chemical Co., Ltd.) and 0.5 g of a chloroplatinic acid catalyst (1% chloroplatinic acid solution). Further 100 ml of hexane was added. The mixture in patty form was thoroughly mixed and then heated at 60° C. for removing the solvent and precuring. It was cured in air at 200° C. for one hour.

The cured mixture in mass form was crushed and then milled in a ball mill, using hexane as a dispersing medium, to an average particle size of 15 μm. After removal of the solvent, the powder was placed in a lidded alumina container and fired in an atmosphere-controllable, temperature-programmable muffle furnace in a nitrogen atmosphere at 1,000° C. for 3 hours. After cooling, the fired product was pulverized on a grinder (Masscolloider) with a set clearance of 20 μm, yielding Si—C—O composite powder having an average particle size of about 10 μm.

In a globe box under an argon blanket, a portion (9.3 g) of the Si—C—O composite powder was weighed and placed in a glass vial with an internal volume of about 50 ml. Stabilized lithium powder SLMP (FMC Corp.), 0.7 g, was added to the vial, which was closed with a cap and manually shaken for mixing. The mixture was transferred to a 500-ml stainless steel jar of a planetary ball mill PM-100 (Retsch GmbH), containing ten stainless steel balls of each 32 g. The jar was closed, taken out of the globe box, and mounted in place on the planetary ball mill PM-100. The jar was rotated at a rotational speed of 500 rpm in forward and backward directions each for 10 minutes. The jar was allowed to cool, after which the silicon-silicon oxide-lithium composite was taken out. It was analyzed by X-ray diffractometry, finding that it was amorphous, as in Example 1.

Using a vertical tubular furnace (inner diameter ˜50 mm), the composite powder was subjected to thermal CVD in a methane-argon mixture stream at 1,100° C. for 3 hours. The black mass thus obtained was disintegrated in an automated mortar. The carbon-coated SiCO—Li composite powder had a surface coating carbon content of 14% and an average particle size of 13 μm. That is, CVD by 1100° C./3 hr contact with methane-argon gas mixture produced a carbon coat of about 14%.

As in Example 1, the carbon-coated SiCO—Li composite powder was evaluated as the negative electrode active material for a lithium ion secondary cell. The results are shown in Table 1.

### Comparative Example 1

As in Example 2, a silicone powder X-52-1621 (Shin-Etsu Chemical Co., Ltd.) which is a spherical, trifunctional, highly crosslinked methylsiloxane polymer of the general formula: (CH₃SiO_{3/2})ₙ and has an average particle size of about 10 μm was placed in a lidded alumina container. The container was placed in an atmosphere-controllable, temperature-programmable muffle furnace where the powder was fired in a nitrogen atmosphere at 1,000° C. for 3 hours. After cooling, the fired product was pulverized on a grinder (Masscolloider) with a set clearance of 20 μm, yielding Si—C—O composite powder having an average particle size of about 10 μm.

Using a vertical tubular furnace (inner diameter ˜50 mm), the Si—C—O composite powder was subjected to thermal CVD in a methane-argon mixture stream at 1,100° C. for 3 hours. The black mass thus obtained was disintegrated in an automated mortar. The carbon-coated Si—C—O composite powder had a surface coating carbon content of 14% and an average particle size of 12 μm.

As in Example 1, the carbon-coated Si—C—O composite powder (lithium undoped) was evaluated as the negative electrode active material for a lithium ion secondary cell. The results are shown in Table 1.

### Comparative Example 2

A block or flake form of silicon oxide was milled on a ball mill using hexane as a dispersing medium. By filtering the resulting suspension and removing the solvent in a nitrogen atmosphere, a powder having an average particle size of about 10 μm was obtained. Using a vertical tubular furnace (inner diameter ˜50 mm), the silicon oxide powder was subjected to thermal CVD in a methane-argon mixture stream at 1,100° C. for 3 hours. The black mass thus obtained was disintegrated in an automated mortar. The carbon-coated silicon oxide powder had a surface coating carbon content of 16% and an average particle size of 12 μl. It was evaluated as the negative electrode active material for a lithium ion secondary cell as in Example 1. The results are shown in Table 1.

TABLE 1

| | | | | Comparative | |
|---|---|---|---|---|---|
| | Example | | | Example | |
| | 1 | 2 | 3 | 1 | 2 |
| General formula | SiC₂O—Li | SiCO_{3/2}—Li | C/SiC₂O—Li | SiCO_{3/2} | SiO |
| Li added (wt %) | 15 | 15 | 7 | 0 | 0 |
| Carbon coat (wt %) | 14 | 15 | 14 | 15 | 16 |
| Initial charge capacity* | 1030 | 1050 | 960 | 1400 | 2200 |
| (mAh/g) | | | | | |
| Initial discharge capacity* | 830 | 830 | 760 | 880 | 1400 |
| (mAh/g) | | | | | |
| Initial efficiency (%) | 81 | 79 | 79 | 62 | 62 |
| Cycle retention | 90 | 92 | 92 | 90 | 85 |
| at 50th cycle (%) | | | | | |

*The Capacity is calculated based on the weight of CVD carbon-containing siliceous active material (excluding graphite value added in the cell test for imparting conductivity).

Example 1 corresponds to carbon-coated SiCO—Li composite particles (hydrosilylation, highly-crosslinked).

Example 2 corresponds to carbon-coated SiCO—Li composite particles (MeSiO_{3/2} highly-crosslinked silicone powder).

Example 3 corresponds to carbon-coated graphite/SiCO—Li composite particles.

Comparative Example 1 corresponds to carbon-coated SiCO composite particles (MeSiO_{3/2} highly-crosslinked silicone powder).

Comparative Example 2 corresponds to carbon-coated silicon oxide.

Japanese Patent Application No. 2006-085440 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A SiCO—Li composite prepared by sintering a crosslinked product of a reactive silane or siloxane having crosslinkable groups or a mixture thereof into an inorganic Si—C—O composite, and doping the Si—C—O composite with metallic lithium or an organolithium compound.

2. The SiCO—Li composite of claim 1, wherein said crosslinked product is spherical silicone powder.

3. The SiCO—Li composite of claim 1, wherein a particulate additive selected from the group consisting of graphite and silicon powder, and graphite and silicon powder which have been surface treated with an organosilicon surface treating agent is added to the reactive silane or siloxane having crosslinkable groups or the mixture thereof, prior to the formation of the crosslinked product.

4. The SiCO—Li composite of claim 1, wherein the reactive silane or siloxane is one or more of silanes or siloxanes having the general formulae (1) to (5): 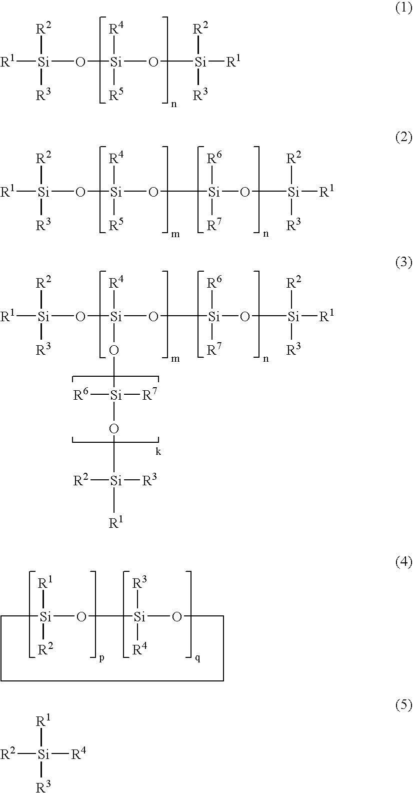
wherein R¹ to R⁷ are each independently a hydrogen atom, hydroxyl group, hydrolyzable group or monovalent hydrocarbon group, with the proviso that in each of the compounds of formulae (1) to (5), at least two silicon-bonded substituent groups are hydrogen atoms, hydroxyl groups, hydrolyzable groups or aliphatic unsaturated hydrocarbon groups, m, n and k each are a number of 0 to 2,000, p and q each are a number of 0 to 10, p and q are not equal to 0 at the same time.

5. The SiCO—Li composite of claim 1, wherein the reactive silane or siloxane is derived from a silane or siloxane having the average formula: C_{w}HₓSiO_{y}N_{z} wherein w and x are positive numbers, y and z are 0 or positive numbers, and (w−y) is greater than 0, and including at least one crosslinkable site per four silicon atoms.

6. The SiCO—Li composite of claim 1, having an average particle size of 0.1 to 30 μm.

7. A surface conductive SiCO—Li composite comprising the SiCO—Li composite of claim 1, the surface of which is coated with carbon.

8. A method for preparing a SiCO—Li composite comprising the steps of:
curing a reactive silane or siloxane having crosslinkable groups or a mixture thereof through heat curing or catalytic reaction to form a crosslinked product,
sintering the crosslinked product in an inert gas stream at a temperature in the range of 700 to 1,400° C. into an inorganic Si—C—O composite, and
adding metallic lithium or an organolithium compound to the Si—C—O composite for doping.

9. A method for preparing a SiCO—Li composite comprising the steps of:
crosslinking a reactive silane or siloxane having crosslinkable groups or a mixture thereof by an emulsion process to form a spherical silicone powder,
sintering the powder in an inert gas stream at a temperature in the range of 700 to 1,400° C. into an inorganic Si—C—O composite, and
adding metallic lithium or an organolithium compound to the Si—C—O composite for doping.

10. The method of claim 8, further comprising the step of adding an additive to the reactive silane or siloxane having crosslinkable groups or the mixture thereof, prior to the curing or crosslinking step,
said additive serving as conductive agent and/or lithium-occluding material and being selected from the group consisting of graphite and silicon powder, and graphite and silicon powder which have been surface treated with at least one organosilicon surface treating agent selected from among silane coupling agents, (partial) hydrolyzates thereof, silylating agents, and silicone resins.

11. The method of claim 8, wherein the reactive silane or siloxane is one or more of silanes or siloxanes having the general formulae (1) to (5): 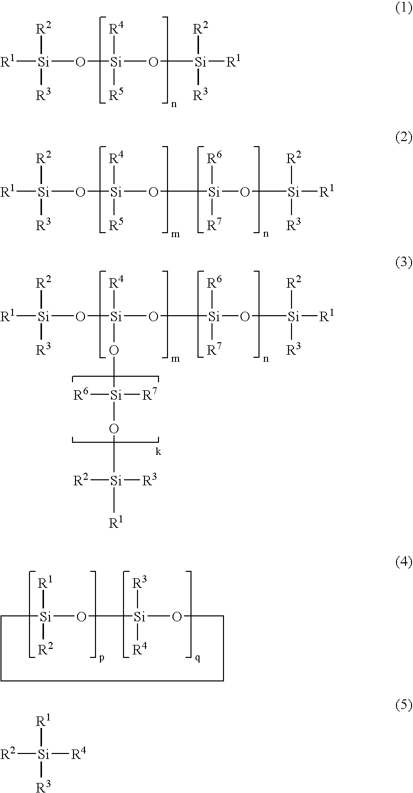
wherein R¹ to R⁷ are each independently a hydrogen atom, hydroxyl group, hydrolyzable group or monovalent hydrocarbon group, with the proviso that in each of the compounds of formulae (1) to (5), at least two silicon-bonded substituent groups are hydrogen atoms, hydroxyl groups, hydrolyzable groups or aliphatic unsaturated hydrocarbon groups, m, n and k each are a number of 0 to 2,000, p and q each are a number of 0 to 10, p and q are not equal to 0 at the same time.

12. The method of claim 8, wherein the reactive silane or siloxane is derived from a silane or siloxane having the average formula: C_{w}HₓSiO_{y}N_{z} wherein w and x are positive numbers, y and z are 0 or positive numbers, and (w−y) is greater than 0, and including at least one crosslinkable site per four silicon atoms.

13. The method of claim 8, further comprising, after the addition of metallic lithium or organolithium compound, reducing it for lithiation, and grinding the composite to an average particle size of 0.1 to 30 μm.

14. A method for preparing a surface conductive SiCO—Li composite, comprising the step of depositing carbon on the surface of the SiCO—Li composite prepared by the method of claim 8, through CVD.

15. A negative electrode material for use in a non-aqueous electrolyte secondary cell, comprising the SiCO—Li composite of claim 1.

16. A negative electrode material for use in a non-aqueous electrolyte secondary cell, comprising a mixture of the SiCO—Li composite of claim 1 and a conductive agent, the mixture containing 5 to 60% by weight of the conductive agent and having a total carbon content of 5 to 90% by weight.
